(19) United States
(12) Patent Application Publication
(10) Pub. No.: US 2022/0227967 A1
(43) Pub. Date: Jul. 21, 2022

(54) Coloured material based on metal nanoparticles

(71) Applicants: UNIVERSITE DE BORDEAUX, BORDEAUX (FR); CENTRE NATIONAL DE LA RECHERCHE SCIENTIFIQUE, PARIS (FR)

(72) Inventors: Jérôme MAJIMEL, PORTETS (FR); Lydia ROUDIER, SAINT JEAN D'ILLAC (FR); Uli CASTANET, BORDEAUX (FR)

(21) Appl. No.: 17/614,634

(22) PCT Filed: May 27, 2020
(86) PCT No.: PCT/FR2020/050895

§ 371 Date: Nov. 29, 2021

(30) Foreign Application Priority Data
May 28, 2019 (FR) FR1905635

(51) Int. Cl. C08K 9/12; C09C 1/64; C09C 3/06

(52) U.S. Cl. CPC C08K 9/12; C09C 1/642; C09C 3/066; C09C 3/063; C08K 2201/005; C01P 2004/84; C01P 2004/03; C01P 2004/04; C01P 2004/61; C01P 2004/20

(57) ABSTRACT

The invention relates to methods for producing coloured materials with the use of metal nanoparticles of gold, copper or silver, to said coloured materials, and to the uses of same in various applications.

The present invention relates to processes for preparing colored materials that employ metal nanoparticles of gold, copper or silver, to said colored materials, and to uses thereof in diverse applications.

It applies more particularly to materials comprising metal nanoparticles having optical properties based on the phenomenon of surface plasmon resonance.

### PRIOR ART

The use of a metal in the form of nanoparticles may allow a suspension or a solid substrate comprising said nanoparticles to take on a color different than the original color of the solid metal (i.e., the metal not in the form of nanoparticles). The reason is that when a metal particle is subjected to an electromagnetic field with a wavelength much greater than the size of the particles: λ>>Ø_{particles}, all of the free electrons in the conduction band are subject to the same field and oscillate collectively and in phase. When the frequency of the incident wave corresponds to the natural frequency of these oscillations, a resonance phenomenon occurs which is called plasmon resonance. This resonance takes place in the visible range, only for gold, copper and silver this being responsible for the particular coloration of the nanoparticles of these metals. Gold nanoparticles of 20 nm typically have a plasmon resonance band at 520 nm (absorption in the green) and are red. The plasmon resonance frequency is dependent on the nature of the metal, on the size of the particle and on its shape, and also on the dielectric properties of the substrate or of the surrounding medium (e.g., suspension) and on inter-particle interactions. These various parameters can be tailored in order to vary the color of the gold nanoparticles throughout the visible range, or even to shift the plasmon resonance frequency into the near infrared.

International patent application WO2011035446 A1 describes the manufacture of a colored material by mixing an organic-inorganic matrix based on a thermosetting or photopolymerizable resin with a suspension or dispersion of noble metal nanoparticles surrounded by a shell (based on oxide, in particular), depositing the mixture in a cavity of a substrate, and polymerizing the mixture. This process provides access to a material colored in hues of pink or red within the cavity. The hues obtained are limited and are localized in a specific site on the substrate.

### DESCRIPTION OF THE INVENTION

The aim of the present invention is therefore to overcome the disadvantages stated above, and more particularly to provide a process for manufacturing a colored material which is capable where appropriate of color change under the influence of at least one stimulus, said process being simple, economic, guaranteeing optimal color stability, producing an extremely well-defined spectrum of colors, having a substantial modularity in that it provides access to a substantial range of colors and types of colored substrates, and as far as possible avoiding transfers of solvents.

The invention firstly provides a process for preparing a colored material, characterized in that it comprises at least the following steps:

i) a step of heating an aqueous suspension comprising:
at least one gold (+III) salt or at least gold nanoparticles,
at least one reducing agent, and
at least one micron-scale particulate carrier,
   to form said colored material in suspension, and

ii) a step of recovering said colored material,

said colored material being in the form of gold nanoparticles carried by said micron-scale particulate carrier.

The process for manufacturing the colored material is simple, economic, guarantees optimal color stability, produces an extremely well-defined spectrum of colors, exhibits substantial modularity, and as far as possible avoids transfers of solvents.

In the present invention, the expression “nanoparticles” refers to particles having at least one dimension less than or equal to 500 nm, preferably less than or equal to 250 nm, and with particular preference less than or equal to 100 nm approximately.

Considering a plurality of nanoparticles according to the invention, the term “dimension” refers to the number-average dimension of the collective particles of a given population, this dimension being conventionally determined by methods well known to the skilled person. The dimension of the particle or particles according to the invention may be determined, for example, by microscopy, especially by scanning electron microscope (SEM) or by transmission electron microscope (TEM).

The gold (+III) salt is a salt in which the gold is in the (+III) oxidation state.

According to one embodiment, the gold (+III) salt is selected from tetrachloroauric acid HAuCl₄, potassium tetrachloroaurate KAuCl₄, and a mixture thereof, and preferably KAuCl₄.

The gold nanoparticles are gold nanoparticles in which the gold is in the zero oxidation state.

The aqueous suspension may comprise one or more solvents, the one or more solvents containing at least 50% by volume approximately of water, preferably at least 80% by volume approximately of water, and with particular preference 100% by volume approximately of water, relative to the total volume of solvent(s) in the aqueous suspension.

The heating in step i) may be performed by temperature heating, more particularly using a hotplate, or by microwave heating.

The temperature heating may be carried out at a temperature of from 30 to 200° C. approximately, and with particular preference from 50 to 110° C. approximately.

The microwave heating may be carried out at a frequency of from 25 to 65 Hz approximately, and preferably of the order of 45 kHz.

Via the temperature or the frequency employed it is possible to modulate the rate of deposition of the gold nanoparticles on the carrier, and hence the coloristic effects obtained.

Step i) may be performed with stirring, for example with mechanical or magnetic stirring.

The aqueous suspension used in step i) may comprise from 0.005 to 1.0% by mass approximately of gold (+III) salt, and preferably from 0.01 to 0.5% by mass approximately of gold (+III) salt, relative to the total mass of said aqueous suspension.

The aqueous suspension used in step i) may comprise from 0.05 to 1.0% by mass approximately of reducing agent, and preferably from 0.08 to 0.5% by mass approximately of reducing agent, relative to the total mass of said aqueous suspension.

According to one preferred embodiment of the invention, the mass ratio in the aqueous suspension used in step i): mass of gold (+III) salt/mass of reducing agent varies from 0.1 to 1.5 approximately, and preferably from 0.1 to 1.0 approximately.

The aqueous suspension used in step i) may comprise from 0.002 to 0.6% by mass approximately of gold nanoparticles, and preferably from 0.04 to 0.3% by mass approximately of gold nanoparticles, relative to the total mass of said aqueous suspension.

According to one preferred embodiment of the invention, the mass ratio in the aqueous suspension from step i): mass of gold nanoparticles/mass of reducing agent varies from 0.05 to 0.55 approximately, and preferably from 0.1 to 0.5 approximately.

The reducing agent may be selected from alkali metal citrates; citrates of zwitterionic derivatives of amino acids; borohydrides; hydrazine, hydroquinone, and a mixture thereof, and preferably selected from alkali metal citrates, citrates of zwitterionic amino acids, and a mixture thereof.

Examples of borohydrides include sodium borohydride.

Examples of alkali metal citrates include sodium or potassium citrate.

Examples of citrates of zwitterionic derivatives of amino acids include the citrates of derivatives comprising at least one carboxylate function and at least one quaternary ammonium function, such as betaine citrate.

The aqueous suspension used in step i) may further comprise a stabilizer, especially when the reducing agent has no stabilizing or surfactant properties. For example, the citrates exhibit stabilizing properties as well as their reducing power.

The stabilizer may be selected from polymers such as polyvinyl alcohol or polyacrylic acid, poly(ethylene glycol) (PEG), sulfur derivatives such as thiols, ligands based on triphenylphosphine, dendrimers, and surfactants such as cetyltrimethylammonium bromide (CTAB), sodium dodecyl sulfate (SDS) or amine surfactants.

Sodium citrate and betaine citrate are particularly preferred (as reducing agents having stabilizing properties).

In the invention, the expression “micron-scale particulate carrier” means that the carrier is in the form of micron-scale particles.

More particularly, the micron-scale particles acting as carriers for the gold nanoparticles may have at least one dimension less than 300 μm approximately, preferably of from 50 nm to 150 μm approximately, and with particular preference from 1 to 100 μm approximately.

The micron-scale particulate carrier may be organic or inorganic.

Said carrier may comprise or consist of an inorganic material selected from silicates such as, for example, micas, borosilicates, or talc; glasses such as silica; metal oxides, such as zinc oxide, for example; rare earth oxides such as cerium oxide; metals such as aluminum, for example; and a mixture thereof; or may comprise or consist of an organic material selected from materials derived from natural compounds such as oyster powders or oyster shell powders, and derivatives of materials obtained from the forestry and wood industry such as cellulose or its derivatives.

An inorganic particulate carrier is preferred.

The particulate carrier may be in the form of flakes, platelets, polyhedrons, beads, especially solid or hollow beads, particles, spherical particles for example, or a powder.

According to one preferred embodiment of the invention, the carrier comprises at the surface a layer containing at least one metal oxide. In other words, the material of the carrier may be coated with a layer containing at least one metal oxide. This therefore enables the gold nanoparticles to attach to said carrier more easily. In this embodiment, the carrier is preferably inorganic.

Furthermore, the layer containing at least one metal oxide may be hydrophilic or hydrophobic in nature. Different colors may be obtained according to the nature of the layer.

The layer containing at least one metal oxide may have a thickness of from 5 to 200 nm approximately, preferably of from 30 to 160 nm approximately, and with particular preference of from 50 to 145 nm approximately. Different colors may be obtained according to the thickness of the layer. These thickness ranges enable more effective control of the final color of the pigment, while ensuring access to a large range of different colors.

The layer containing at least one metal oxide may be a layer of silica, such as of amorphous silica, for example.

According to one preferred embodiment of the invention, the carrier is selected from aluminum flakes, preferably comprising a silica layer; borosilicate flakes, preferably comprising a metal oxide layer; silica beads; mica particles; zinc oxide particles; calcium oxide particles; cerium oxide particles; talc particles; cellulose beads and flakes; and an oyster shell powder.

The aluminum flakes coated with a layer of silica are sold for example under the Frost, Crystal or Velvet designations by Toyal Europe.

The borosilicate flakes coated with a metal oxide layer are sold for example under the designation KT700 by Kolortek.

The silica beads are sold for example under the designation CL-Silica-900 by Maprecos.

The mica particles are sold for example under the designation C86-6105 Satin Mica by Maprecos.

The zinc oxide particles are sold for example by Sigma Aldrich.

The calcium oxide particles are sold for example by Sigma Aldrich.

The aqueous suspension used in step i) may comprise from 0.005 to 60% by mass approximately, preferably from 0.01 to 50% by mass approximately, and with particular preference from 0.1 to 10% by mass approximately, of micron-scale particulate carrier, relative to the total mass of said aqueous suspension.

Step i) may last from 0.5 to 120 minutes approximately, and preferably from 2 to 45 minutes approximately.

According to one preferred embodiment of the invention, the process further comprises, before step i), a step i0) of preparing the aqueous suspension.

According to a first variant of the process of the invention, step i) employs at least one gold (+III) salt.

In the first variant of the process of the invention, the gold nanoparticles are prepared in situ.

According to this first variant, step i0) of preparing the aqueous suspension may more particularly comprise the following substeps:

i0-1) preparing an aqueous solution comprising the gold (+III) salt,

i0-2) preparing an aqueous solution comprising the reducing agent, and

i0-3) adding the micron-scale particulate carrier and the aqueous solution obtained in substep i0-1) to the aqueous solution from substep i0-2).

Substep i0-1) may be performed at ambient temperature (i.e. 18-25° C.).

Substep i0-2) may be performed at ambient temperature (i.e. 18-25° C.).

Step i0) of preparing the aqueous suspension may further comprise, after substep i0-2) and before substep i0-3), a substep i0-2′) of heating the aqueous solution obtained in substep i0-2).

The heating in substep i0-2′) may be performed by temperature heating, more particularly using a hotplate, or by microwave heating.

The temperature heating may be carried out at a temperature of from 80 to 200° C. approximately, and with particular preference from 80 to 110° C. approximately.

The microwave heating may be carried out at a frequency of from 25 to 65 Hz approximately, and preferably of the order of 45 kHz.

In substep i0-3), the proportion of aqueous solution of gold (+III) salt added is such that the volume ratio: volume of the aqueous solution comprising the gold (+III) salt obtained in substep i0-1)/volume of the aqueous solution comprising the reducing agent obtained in substep i0-2) is preferably from 0.1 to 2.5 approximately, and with particular preference from 0.5 to 2.0.

Substep i0-3) may be performed once (i.e., the entire amount of gold (+III) salt solution is added in one go) or multiple times.

When step i0) comprises substep i0-2′), the heating is maintained during substeps i0-3) and i).

According to a second variant of the process of the invention, step i) employs at least gold nanoparticles.

This second variant enables prior preparation of the gold nanoparticles before they are contacted with the particulate micron-scale carrier, thereby allowing greater latitude with regard to the selection of the carrier, the form of gold nanoparticles, and the recycling options for the raw materials.

According to this second variant, the gold nanoparticles may be obtained beforehand by any method well known in the prior art, such as the Turkevich method.

According to this second variant, step i0) of preparing the aqueous suspension may comprise more particularly the following substeps:

i0-A) preparing an aqueous solution comprising the gold nanoparticles,

i0-B) adding the reducing agent, and

i0-C) adding the micron-scale particulate carrier.

The aqueous suspension of substep i0-A) may be obtained by any method well known in the prior art, such as the Turkevich method.

The step ii) of recovering said colored material may be carried out by filtration, settling, or centrifugation.

The process may further comprise a step iii) of drying, in particular by stoving.

The process may further comprise a step iv) of employing a stimulus to modify the color of the colored material.

The stimulus may be external stimulus such as the heating or baking of the colored material obtained in step ii) or iii), exposure to UV radiation, the use of a laser, or its spontaneous or induced rehydration.

The gold nanoparticles of the colored material obtained by the process conforming to the first subject of the invention preferably have at least one dimension of from 5 to 100 nm approximately.

The invention secondly provides a colored material obtained by a process conforming to the first subject of the invention, characterized in that it is in the form of gold nanoparticles carried on a micron-scale particulate carrier.

The gold nanoparticles and the micron-scale particulate carrier may be as defined in the first subject of the invention.

The colored material may comprise from 1 to 20% by mass approximately of gold and from 99 to 80% by mass approximately of micron-scale particulate carrier, relative to the total mass of the colored material.

The colored material is preferably in the form of a powder or a pulverulent material.

The gold nanoparticles in the colored material obtained by the process conforming to the second subject of the invention preferably have at least one dimension of from 2 to 100 nm approximately.

The invention thirdly provides a colored composition comprising at least one colored material conforming to the second subject of the invention or obtained by a process conforming to the first subject of the invention, and at least one solvent in which said colored material is dispersed.

The solvent may be an organic solvent, such as a solvent selected from alcohols such as ethanol and from esters such as ethyl acetate, or an aqueous solvent.

The colored composition may further comprise any additive suitable for forming a nail varnish base, more particularly translucent or transparent.

Such additives may be selected from a film former, a plasticizer, a thixotropic agent, a resin, and a mixture thereof. These additives are well known to the skilled person.

In the invention, the expression “translucent” means having an optical transmission coefficient of from 10% approximately to 80% approximately, measured by a conventional UV-visible spectrometer. In the invention, the expression “transparent” means having an optical transmission coefficient of greater than 80% approximately, measured by a conventional UV-visible spectrometer.

The colored composition may be obtained by mixing the colored material with at least one organic solvent and optionally the aforesaid additive or additives.

The colored composition may be applied to a carrier, such as a rigid or flexible carrier, for example, and dried, to form a carrier comprising the continuous colored layer.

The carrier may be selected from a leather, fabric, polymer-material, or metal surface.

Application may be performed with an airbrush, or by brush.

The invention fourthly provides a process for preparing a colored material, characterized in that it comprises at least the following steps:

a) a step of preparing a crosslinkable composition comprising one or more epoxy precursors,

b) a step of mixing the crosslinkable composition from step a) with a suspension in a polar protic solvent of metal nanoparticles of a metal selected from gold, copper, silver, and a mixture thereof, to give a colored composition, and

c) a step of polymerizing, and

in that said colored material is in the form of metal nanoparticles of a metal selected from gold, copper, silver, and a mixture thereof, dispersed in a crosslinked epoxy polymer material.

The process for producing the colored material is simple, economic, ensures optimum color stability, enables an extremely well-defined spectrum of colors to be obtained, exhibits substantial modularity, and as far as possible avoids transfers of solvents.

Step a) may be performed with stirring, especially in the presence of ultrasound. This therefore allows a homogeneous mixture to be formed, while avoiding the presence of air bubbles.

Step a) is preferably performed at ambient temperature (i.e., 18-25° C. approximately).

For the purposes of the invention, the epoxy precursor comprises one or more epoxide groups (or oxirane rings).

The epoxy precursor of the crosslinkable composition may be selected from cycloaliphatic epoxy resins, glycidyl ether epoxy resins, especially (poly)phenol and/or aliphatic glycidyl ether epoxy resins, glycidyl ester epoxy resins, epoxy resins obtained by copolymerization with glycidyl methacrylate, and epoxy resins obtained from unsaturated fatty acid glycerides.

Preferred examples of epoxy precursors include the glycidyl ether epoxy resins, especially (poly)phenol and/or aliphatic glycidyl ether epoxy resins, such as the products of a condensation reaction of epichlorohydrin with polyalcohols or polyphenols (e.g., bisphenol A, bisphenol F), aliphatic epoxy resins of glycidyl ethers, or a mixture thereof.

Step b) is preferably performed by adding the suspension of metal nanoparticles to the crosslinkable composition, more particularly multiple times and/or gradually.

Step b) may be performed with stirring, especially in the presence of ultrasound. This therefore enables the formation of a homogeneous mixture, while avoiding the presence of air bubbles.

The protic polar solvent may be selected from lower (i.e., C₁-C₅) alcohols.

The protic polar solvent is preferably ethanol.

In step b), the molar concentration of the metal nanoparticles in the suspension is preferably from 1×10⁻⁹ to 1×10⁻⁷ mol/l approximately, and with particular preference from 5×10⁻⁹ to 5×10⁻⁸ mol/l approximately.

At the end of step b), the mass ratio: mass of metal nanoparticles/mass of crosslinkable epoxy precursors is from 3×10⁻⁹ to 3×10⁻⁷ approximately and preferably from 1.5×10⁻⁸ to 1.5×10⁻⁷.

Step b) is preferably performed at ambient temperature.

Step c) is preferably performed at ambient temperature. Step c) may last from 5 minutes to 24 hours approximately.

Steps b) and c) may be concomitant, or step c) may take place before or after step b).

Step c) may be a photopolymerization step or a step employing at least one crosslinking agent.

The crosslinking agent is preferably introduced into the crosslinkable composition in step a).

The crosslinked epoxy polymer material is therefore obtained by polymerizing at least epoxy precursor as defined in the invention and the crosslinking agent (also called hardener), especially by polycondensation or by polyaddition.

The crosslinking agent may be based on at least one acid anhydride, at least one polyamine (e.g., (cyclo)aliphatic amines, aromatic amines), at least one polyamide, at least one amidoamine, or a mixture thereof.

Examples of acid anhydrides include methyltetrahydrophthalic (MTHPA) or methylnadic anhydride (NMA) or methylhexahydrophthalic anhydride (MHHPA).

Examples of polyamines of aliphatic or cycloaliphatic amine type include those comprising two primary amines such as diethylene triamine (DETA), tetraethylene tetramine (TETA), polyetheramines such as polyoxypropylene diamine, or the compounds sold under the Jeffamine® name, or isophorone diamine (IPDA).

Examples of polyamines of aromatic amine type include those comprising two primary amines such as 4,4′-diaminodiphenylmethane (DDM), diaminodiphenyl sulfone (DDS), methylenebis(diisopropylaniline) (MPDA) or bis(aminochlorodiethylphenyl)methane (MCDEA).

Examples of polyamides include the products of the condensation of polyamines with fatty acids or acid dimers.

Examples of amidoamines include the products of reaction of carboxylic acids (derivatives of C₁₆-C₁₉ fatty acids) with aliphatic polyamines (TETA).

The process may further comprise, between steps b) and c), a step b′) in which the colored composition is cast in a mold, more particularly in a silicone mold.

Step c) may be concomitant with step b′).

According to this embodiment, step c) may be followed by a step d) in which the colored material obtained is demolded.

The suspension of metal nanoparticles as is used in step b) may be obtained by techniques well known to the skilled person.

When the metal nanoparticles are gold nanoparticles, the suspension of metal nanoparticles may be obtained, for example, by preparing an aqueous suspension of gold nanoparticles by the Turkevich method, then by solvent transfer, causing the water to be replaced with a polar protic solvent as defined in the invention.

The metal nanoparticles in the colored material obtained by the process conforming to the fourth subject of the invention preferably have at least one dimension of from 2 to 100 nm approximately.

The metal nanoparticles are preferably nanoparticles of a metal selected from copper, silver, a mixture of copper and silver, or a mixture of copper, silver and gold.

The metal nanoparticles may be coated with an organic or inorganic layer.

They may, however, be free of an organic or inorganic layer, and more particularly free of an organic layer, especially when the metal nanoparticles are gold particles.

The organic layer may comprise a material selected from polymers such as polyvinyl alcohol or polyacrylic acid, poly(ethylene glycol) (PEG), sulfur derivatives such as thiols, ligands based on triphenylphosphine, dendrimers, surfactants such as cetyltrimethylammonium bromide (CTAB), sodium dodecyl sulfate (SDS) or amine surfactants, and preferably such as polyvinyl alcohol or polyacrylic acid, poly(ethylene glycol) (PEG), ligands based on triphenylphosphine, dendrimers, and surfactants such as cetyltrimethylammonium bromide (CTAB), sodium dodecyl sulfate (SDS) or amine surfactants.

The organic layer is preferably different than a layer comprising a polyvinylpyrrolidone such as poly-N-vinyl-2-pyrrolidone, or a thiol such as dodecane thiol, especially when the metal nanoparticles are gold particles.

The inorganic layer may comprise a metal oxide or metalloid oxide such as, for example, a layer of silicon oxide.

An inorganic layer of silica is particularly suitable for silver or gold nanoparticles.

When the metal nanoparticles are coated with an organic or inorganic layer, the process may further comprise, before step b), a step a′) of coating the nanoparticles.

The process may further comprise, in step b) or between steps b) and c), adding a color modifier to the colored composition.

This modifier modifies the color of the colored composition.

The process may further comprise a step e) of employing a stimulus to modify the color of the colored material.

This step e) may allow a material having a homogeneous distribution of metal nanoparticles to become a material having within it a heterogeneous distribution of the metal nanoparticles, thereby causing a change in color.

Step e) is particularly suitable when the metal nanoparticles are silver and gold nanoparticles.

The stimulus may be an external stimulus such as heating or baking of the colored material obtained in step c), an exposure to UV radiation, or the use of a laser.

The stimulus may be an internal stimulus such as the step c) of polymerization “proper”, or the pH of the crosslinkable composition, and especially of the crosslinking agent or hardener.

The crosslinked epoxy polymer material of the colored material is obtained from the crosslinkable composition as defined in the invention.

The invention fifthly provides a colored material obtained by a process conforming to the fourth subject of the invention, characterized in that it is in the form of metal nanoparticles of a metal selected from gold, copper, silver, and a mixture thereof, dispersed in a crosslinked epoxy polymer material.

The colored material obtained by a process conforming to the fourth subject of the invention is preferably different than a colored material in the form of gold nanoparticles dispersed in a crosslinked epoxy polymer material, said gold nanoparticles comprising an organic layer comprising a polyvinylpyrrolidone such as poly-N-vinyl-2-pyrrolidone, or a thiol such as dodecane thiol.

The metal nanoparticles and the crosslinked epoxy polymer material may be as defined in the fourth subject of the invention.

The colored material may comprise from 0.5 to 10% by mass approximately of metal nanoparticles and from 90 to 99.5% by mass approximately of crosslinked epoxy polymer material, relative to the total mass of the colored material.

The colored material is preferably in the form of a solid mass, i.e., in the form of a nonpulverulent material.

Accordingly, by virtue of the processes of the invention, all of the primary colors of the visible light spectrum are obtained using just one or more metals, and also an infinite range of secondary hues, by simply mixing two or three types of metal nanoparticles, especially in the case of the process conforming to the fourth subject of the invention. The processes also allow the hue of a coloration to be modulated, irreversible and/or photosensitive thermochromic properties to be conferred on certain micron-scale particulate carriers or crosslinked polymer materials, and a range of pigments to be offered in micron-scale sizes, the optical properties of said pigments being provided by the nanoscale entities of which they are composed.

The invention sixthly provides for the use of a colored material conforming to the second subject (or obtained by a process conforming to the first subject) or conforming to the fifth subject of the invention (or obtained by a process conforming to the fourth subject) in cosmetic or perfumery applications, in the field of fashion articles such as buttons, in packaging, in jewelry, in printing, in a paint or a varnish, or as a means of authentication—especially of counterfeiting—or of decoration.

### EXAMPLES

### Example 1: Process for Preparing a Colored Material in the Form of Gold Nanoparticles on Aluminum Flakes Coated with a Layer of Amorphous Silica

A 1.5 g/L aqueous solution of KAuCl₄ was prepared.

A 4 g/L aqueous solution of betaine citrate was prepared.

8 mg of aluminum flakes with an average size of 20 μm, coated with a layer of amorphous silica with an average thickness of 100 nm, sold under the trade name Frost Silver by Toyal Europe, were mixed with 5 mL of the aqueous solution of KAuCl₄ and 3 mL of the betaine citrate solution, to form an aqueous suspension.

For this purpose, the aqueous solution of betaine citrate was heated using a hotplate with magnetic stirring to 100° C. The aluminum flakes were then added and the aqueous solution of KAuCl₄ was added in 3 portions over a period of 15 minutes, during which the heating was maintained.

The resulting suspension was then heated for 10 minutes.

The colored material obtained was recovered by centrifuging, then dried in an oven at 120° C.

The colored material obtained is in the form of carried gold nanoparticles with an average size of 20 nm approximately.

The colored material obtained has a golden color (pantone color: 15-0525).

### Example 2: Process for Preparing a Colored Material in the Form of Gold Nanoparticles on Aluminum Flakes Coated with a Layer of Amorphous Silica

A 1.5 g/L aqueous solution of KAuCl₄ was prepared.

A 4 g/L aqueous solution of betaine citrate was prepared.

3 mg of aluminum flakes with an average size of 20 μm, coated with a layer of amorphous silica with an average thickness of 100 nm, sold under the trade name Velvet by Toyal Europe, were mixed with 4.5 mL of the aqueous solution of KAuCl₄ and 3 mL of the betaine citrate solution, to form an aqueous suspension.

For this purpose, the aqueous solution of betaine citrate was heated using a hotplate with magnetic stirring to 100° C. The aluminum flakes were then added and the aqueous solution of KAuCl₄ was added in 3 portions over a period of 15 minutes, during which the heating was maintained.

The resulting suspension was then heated for 10 minutes.

The colored material obtained was recovered by centrifuging, then dried in an oven at 120° C.

The colored material obtained is in the form of carried gold nanoparticles with an average size of 20 nm approximately.

The colored material obtained has a pale pink color (pantone color: 5245).

A process identical to that as described above was employed, with the following modifications:
3 mg of the aluminum flakes were mixed with 3 mL of the aqueous solution of KAuCl₄ and 3 mL of the betaine citrate solution, to form an aqueous suspension,
the aqueous solution of KAuCl₄ was added in 1 portion, during which the heating was maintained, and
the resulting suspension was heated for 20 minutes.

The colored material obtained is in the form of carried gold nanoparticles with an average size of 30 nm approximately, forming a semicontinuous layer on the surface of the particles of the micron-scale carrier.

The colored material obtained has a midnight blue color (pantone color: 2705).

### Example 3: Process for Preparing a Colored Material in the Form of Gold Nanoparticles on Aluminum Flakes Coated with a Layer of Amorphous Silica

A 1.5 g/L aqueous solution of KAuCl₄ was prepared.

A 4 g/L aqueous solution of betaine citrate was prepared.

3 mg of aluminum flakes with an average size of 100 μm, coated with a layer of amorphous silica with an average thickness of 100 nm, sold under the trade name Crystal by Toyal Europe, were mixed with 4.5 mL of the aqueous solution of KAuCl₄ and 3 mL of the betaine citrate solution, to form an aqueous suspension.

For this purpose, the aqueous solution of betaine citrate was heated using a hotplate with magnetic stirring to 100° C. The aluminum flakes were then added and the aqueous solution of KAuCl₄ was added in 3 portions over a period of 15 minutes, during which the heating was maintained.

The resulting suspension was then heated for 10 minutes.

The colored material obtained was recovered by centrifuging, then dried in an oven at 120° C.

The colored material obtained is in the form of carried gold nanoparticles with an average size of 30 nm approximately.

The colored material obtained has a fuchsia color in normal incidence and a golden color in glancing incidence (pantone colors: 17-2034 (fuchsia) and 871-C (golden)).

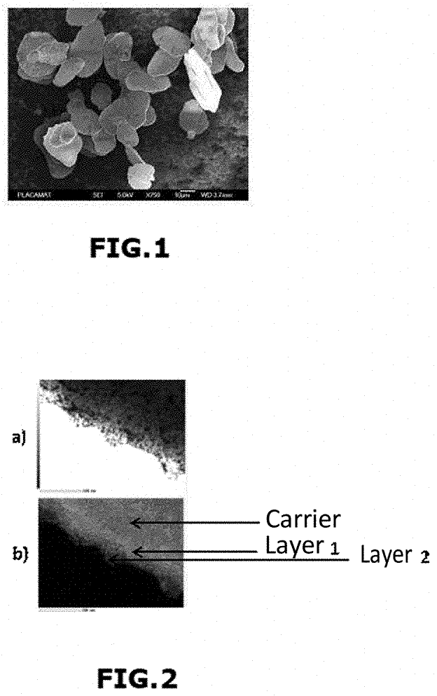

FIG. 1 represents a scanning electron microscopy image of the aluminum plates used as particulate micron-scale carrier in the process of example 3.

FIG. 2 represents STEM-EDX images of the colored material obtained in example 3. FIG. 2 [a) and b)] shows more particularly a deposit of gold particles on an aluminum flake. In FIG. 2b), the carrier represents an aluminum flake and appears in blue, layer 1 represents a layer of amorphous silica and appears in green, and layer 3 represents the gold particles and appears in red.

### Example 4: Process for Preparing a Colored Material in the Form of Gold Nanoparticles Dispersed in an Epoxy Polymer Material

An aqueous solution comprising 20 ml of ultrapure water (with a water resistivity of at least 10 MΩ·cm approximately) and the gold salt HAuCl₄ at 0.25 mM was prepared and stirred vigorously. It was heated to reflux, and then 1 ml of a 1.7×10⁻² M sodium citrate solution was added. The resulting solution was stirred for 20 min, during which the heating to reflux was maintained. The solution turns gray, then violet and finally ruby red in the first few minutes. The resulting solution was subsequently left to cool to ambient temperature. This produced gold nanoparticles with a diameter of 15 nm in aqueous suspension. The aqueous suspension obtained comprises 2.0×10⁻⁹ mol/l of gold nanoparticles.

10 ml of the aqueous suspension obtained above were heated to a temperature slightly lower than 100° C. (without causing the solution to boil, so as not to destabilize the gold nanoparticles) on a hotplate with magnetic stirring. Successive additions of 2 ml of ethanol to the aqueous suspension were then carried out, so as to replace the water with ethanol. The final ethanol suspension obtained comprises 1×10⁻⁸ mol/l of gold nanoparticles.

An epoxy resin was prepared as follows: 10 ml of resin and 5 ml of hardener, sold under the name Résine Cristal by Pebeo, are mixed.

1 ml of the alcoholic suspension of gold nanoparticles is then incorporated with slow stirring into the epoxy resin as prepared above. The mixture obtained is subsequently cast in a silicone mold of desired shape, then left to stand for 24 h until polymerization is complete.

The solid obtained takes the form of a translucent material with a red color (pantone color: 19-1664).

### Example 5: Process for Preparing a Colored Material in the Form of Copper Nanoparticles Dispersed in an Epoxy Polymer Material

A suspension of copper nanoparticles is obtained by the pathway of solvothermal synthesis assisted by microwave heating.

For this purpose, 0.1178 g of CuCl₂, 0.4 g of PVP 10 000 sold under the trade name PVP-10 by Sigma Aldrich, and 40 ml of ethanol are introduced into a Teflon reactor, and the reactor is inserted into a microwave oven. It subsequently undergoes heating according to the following program: temperature rise from the ambient temperature to 140° C. in 5 minutes/no temperature hold/cessation of microwave heating/and return to the ambient temperature by inertia. The microwave heating is carried out at a frequency of 45 Hz. An alcoholic suspension with a vivid yellow-orange color is then obtained.

An epoxy resin was prepared as follows: 10 ml of resin and 5 ml of hardener, sold under the name Résine Cristal by Pebeo, are mixed.

1 ml of the alcoholic suspension of copper nanoparticles is then incorporated with slow stirring into the epoxy resin as prepared above. The mixture obtained is subsequently cast in a silicone mold of desired shape, then left to stand for 24 h until polymerization is complete.

The solid obtained takes the form of a translucent material with a blue color (Pantone color 18-3949).

### Example 6: Process for Preparing a Colored Material in the Form of Silver Nanoparticles Dispersed in an Epoxy Polymer Material

A solution of silver nanoparticles is obtained by the pathway of solvothermal synthesis assisted by microwave heating.

For this purpose, a mixture comprising 0.1578 g of silver nitrate AgNO₃ and 12 ml of a solution of PVP 10 000 sold under the trade name PVP-10 by Sigma Aldrich in ethanol at 33.3 g/L is subjected to ultrasound using an ultrasound tank, in order to dissolve all of the silver salt in the ethanolic solution of PVP, and the resulting mixture is then introduced into a Teflon reactor. The reactor is inserted into a microwave oven. It subsequently undergoes heating according to the following program: temperature rise from the ambient temperature to 150° C. in 2 minutes/temperature hold for 30 seconds at 150° C./cessation of microwave heating/and return to the ambient temperature by inertia. The microwave heating is carried out at a frequency of 45 Hz. An alcoholic suspension with a vivid yellow-orange color is then obtained.

An epoxy resin is prepared as follows: 10 ml of resin and 5 ml of hardener, sold under the name Résine Cristal by Pebeo, are mixed.

1 ml of the alcoholic suspension of silver nanoparticles is then incorporated with slow stirring into the epoxy resin as prepared above. The mixture obtained is subsequently cast in a silicone mold of desired shape, then left to stand for 24 h until polymerization is complete.

The solid obtained takes the form of a translucent material with a yellow color (Pantone color PMS 109).

1. A process for preparing a colored material, said process comprising at least the following steps:
i) a step of heating an aqueous suspension comprising:
at least one gold (+III) salt or at least gold nanoparticles,
at least one reducing agent, and
at least one micron-scale particulate carrier,
to form said colored material in suspension, and
ii) a step of recovering said colored material,
said colored material being in the form of gold nanoparticles carried by said micron-scale particulate carrier.

2. The process as claimed in claim 1, wherein the gold (+III) salt is selected from tetrachloroauric acid HAuCl₄, potassium tetrachloroaurate KAuCl₄, and a mixture thereof.

3. The process as claimed in claim 1, wherein the heating in step i) is performed by temperature heating or by microwave heating.

4. The process as claimed in claim 1, wherein the reducing agent is selected from alkali metal citrates, citrates of zwitterionic derivatives of amino acids, borohydrides, hydrazine, hydroquinone, and a mixture thereof.

5. The process as claimed in claim 1, wherein the micron-scale particulate carrier is in the form of micron-scale particles having at least one dimension less than 300 μm.

6. The process as claimed in claim 1, the micron-scale particulate support is inorganic and comprises an inorganic material selected from silicates; glasses; metal oxides; rare earth oxides; metals; and a mixture thereof.

7. The process as claimed in claim 1, wherein the micron-scale particulate carrier is in the form of flakes, platelets, polyhedrons, beads, particles or a powder.

8. The process as claimed in claim 1, wherein step i) employs at least one gold (+III) salt and the process further comprises, before step i), a step i0) of preparing the aqueous suspension, comprising the following substeps:
i0-1) preparing an aqueous solution comprising the gold (+III) salt,
i0-2) preparing an aqueous solution comprising the reducing agent, and
i0-3) adding the micron-scale particulate carrier and the aqueous solution obtained in substep i0-1) to the aqueous solution from substep i0-2).

9. The process as claimed in claim 1, wherein step i) employs at least gold nanoparticles and the process further comprises, before step i), a step i0) of preparing the aqueous suspension, comprising the following substeps:
i0-A) preparing an aqueous solution comprising the gold nanoparticles,
i0-B) adding the reducing agent, and
i0-C) adding the micron-scale particulate carrier.

10. A colored material obtained by a process as defined in claim 1, wherein said colored is in the form of gold nanoparticles carried on a micron-scale particulate carrier.

11. A colored composition comprising at least one colored material as defined in claim 10; and
at least one solvent in which said colored material is dispersed.

12. A process for preparing a colored material, wherein said process comprises at least the following steps:
a) a step of preparing a crosslinkable composition comprising one or more epoxy precursors,
b) a step of mixing the crosslinkable composition from step a) with a suspension in a polar protic solvent of metal nanoparticles of a metal selected from gold, copper, silver, and a mixture thereof, to give a colored composition, and
c) a step of polymerizing, and
in that said colored material is in the form of metal nanoparticles of a metal selected from gold, copper, silver, and a mixture thereof, dispersed in a crosslinked epoxy polymer material.

13. The process as claimed in claim 12, wherein the protic polar solvent is selected from lower alcohols.

14. The process as claimed in claim 12, wherein said further comprises, between steps b) and c), a step b′) during which the colored composition is cast in a mold.

15. The process as claimed in claim 12, wherein the metal nanoparticles are coated with an organic or inorganic layer.
